(19) United States
(12) Patent Application Publication
(10) Pub. No.: US 2022/0225841 A1
(43) Pub. Date: Jul. 21, 2022

(54) PORTABLE HAND WASHING UNIT

(71) Applicant: Murray O'SHEA, Calgary (CA)

(72) Inventor: Murray O'SHEA, Calgary (CA)

(21) Appl. No.: 17/577,296

(22) Filed: Jan. 17, 2022

Related U.S. Application Data
(60) Provisional application No. 63/138,898, filed on Jan. 19, 2021.

(51) Int. Cl. A47K 1/02; B60P 3/22

(52) U.S. Cl. CPC A47K 1/02; B60P 3/225

(57) ABSTRACT

The present disclosure relates to a portable self-contained hand washing unit having a plurality of separate spaced apart washing stations capable of simultaneously accommodating multiple users.

### CROSS-REFERENCE TO RELATED APPLICATION

This application claims the benefit of U.S. Provisional Patent Application Ser. No. 63/138,898 filed on Jan. 19, 2021. The contents of the aforementioned application are incorporated by reference herein.

### TECHNICAL FIELD

The present disclosure generally relates to hand washing equipment. More specifically, the present disclosure relates to a portable self-contained hand washing unit having a plurality of separate spaced apart washing stations capable of simultaneously accommodating multiple users.

### BACKGROUND

The importance of frequent hand washing has long been recognized as valuable in order to maintain good personal hygiene and limit the spread of pathogens that may cause diseases. These hand washing units typically include a fresh or clean water supply which is dispensed to a sink for washing and a means for storing or disposing of the waste water. For the comfort of the user and to encourage conformity with best hand washing practices it may be advantageous if the hand washing unit also comprises a means for heating the water supplied to the sink. This may be challenging to achieve at locations such as construction or tourist sites, where access to fixed plumbing and power supplies is limited or unavailable.

Additionally, such portable hand washing equipment typically only accommodates a single user at a given time, which is undesirable at locations where large numbers of people congregate, for example sporting events or music concerts. Thus, it would be desirable to provide a hand washing unit that can accommodate multiple users at one time. Furthermore, it would be desirable to allow the multiple users to be spaced apart at the recommended distance specified by health agencies to minimize the spread of pathogens, such as through the air, between the users.

### SUMMARY

The present disclosure provides a portable hand washing unit that may include (a) a base unit; (b) a fresh water tank operable to receive and store a volume of clean water, (c) a waste water tank operable to receive and store a volume of waste water, (d) a plurality of washing stations, each washing station in fluid communication with the fresh water tank and the waste water tank, (e) a water pump in fluid communication with the fresh water tank and the plurality of washing stations; (f) a heating and mixing system in fluid communication with the water pump; and (g) a power source in electrical communication with the water pump and heating and mixing system where: the water pump is operable to disperse clean water from the fresh water tank to the plurality of washing stations; and the heating and mixing system is operable to control the temperature of the clean water dispersed by the water pump to the plurality of the washing

### BRIEF DESCRIPTION OF THE DRAWINGS

In drawings which illustrate embodiments,

FIGS. 1A and 1B are right-side and left-side plan views of a hand washing unit in an operational configuration in accordance with one embodiment of the present disclosure.

FIGS. 1C and 1D are front and rear plan views of the hand washing unit of FIGS. 1A and 1B.

FIG. 1E is a top plan view of the hand washing unit of FIGS. 1A and 1B.

FIGS. 1F and 1G are top plan and side-cross sectional views of a washing station of the hand washing unit of FIGS. 1A and 1B.

FIGS. 2A and 2B are right-side and left-side plan views of the hand washing unit of FIGS. 1A and 1B in a storage or transport configuration.

FIGS. 2C and 2D are front and rear plan views of the hand washing unit of FIGS. 2A and 2B.

FIG. 3 is partial cross-sectional top plan view of the hand washing unit of FIGS. 1A and 1B.

FIG. 4 is a fluid communication schematic of the hand washing unit according to an embodiment of the present disclosure.

FIG. 5 is an electrical communication schematic of the hand washing unit according to an embodiment of the present disclosure.

### DETAILED DESCRIPTION

The present disclosure is generally directed to a portable hand washing unit. More specifically, the present disclosure provides a portable hand washing unit that is self-contained and can accommodate a plurality of users at one time. Advantageously, the hand washing unit is configured to supply water to a plurality of spaced apart washing stations which enables multiple users to access the unit at one time while maintaining suitable spacing between each user. This may be particularly desirable in situations where social distancing is required, for example in situations where it is desired to reduce the risk of the spread of pathogens between users.

The portable hand washing unit of the present disclosure is also configured to be easily transported to and from a location as needed, such as to a movie or television filming location, a construction site, a sporting event, a concert or any other suitable location. Furthermore, because the hand washing unit is self-contained, it may be situated at a remote location, distanced from any utility resources, such as public or private electrical or plumbing resources. In one embodiment, the hand washing unit is a trailer mounted unit and may be towed by a suitable vehicle and unhitched at the desired location.

According to an embodiment, the portable hand washing unit may generally include a fresh water tank, a water pump, a heating and mixing system, a plurality of washing stations and a waste water tank. The fresh water tank is configured to receive and store a volume of fresh (or clean) water for supply to the plurality of washing stations. The water pump is operable to pump the clean water stored in the fresh water tank to the heating and mixing system and to the plurality of washing stations. The heating and mixing system is operable to control the temperature of the clean water supplied to each of the washing stations and may include a water heater and a mixing device or mixing valve. The water heater may be powered by an on-board power source or propane gas and internal flame and is operable to supply heat to the clean water to produce heated water. The mixing device or mixing valve is operable to blend clean water dispersed directly from the fresh water tank to the mixing device or valve with heated water dispersed from the water heater in order to supply clean water to each of the washing stations at a pre-determined temperature and for a pre-determined period of time. Thus, the fresh water tank and water heater are in fluid communication with the mixing device or mixing valve which is in turn in fluid communication with each washing station. Each of the washing stations may include a faucet and a non-porous sink. When the faucet is activated by a user, clean water is dispensed to the sink as waste water. Each sink is in fluid communication with the waste water tank. The waste water tank is operable to collect and store the waste water. The waste water (also known as “grey water”) which may include traces of dirt, grease, food, soap, detergent and other contaminants, may be treated by any suitable water treatment method or disposed.

The hand washing unit also includes an on-board power source for suppling power to operate the water pump, water heater and any other component of the unit which may require power. In an embodiment the power source is an on-board DC power supply.

In one embodiment, the hand washing unit includes at least four washing stations to accommodate at least four users at one time. Each of the washing stations may further include a soap dispenser and a paper towel dispenser. In other embodiments, the hand washing unit may include more than four spaced apart washing stations, such as, but not limited to, five, six, seven, eight, nine, ten or more than 10 washing stations, each of which may include a faucet, sink, soap dispenser and paper towel dispenser.

As the hand washing unit accommodates multiple spaced apart users at one time, it may be ideally suited for use during outbreaks of pathogens that may be spread through the air. The hand washing unit may be utilized at such locations where enhanced socially or physically distanced hand washing is required, such as hospitals or other medical facilities. For example, in response to a virus outbreak or natural disaster, the hand washing unit may be rapidly deployed to the site of a field hospital or other emergency response location.

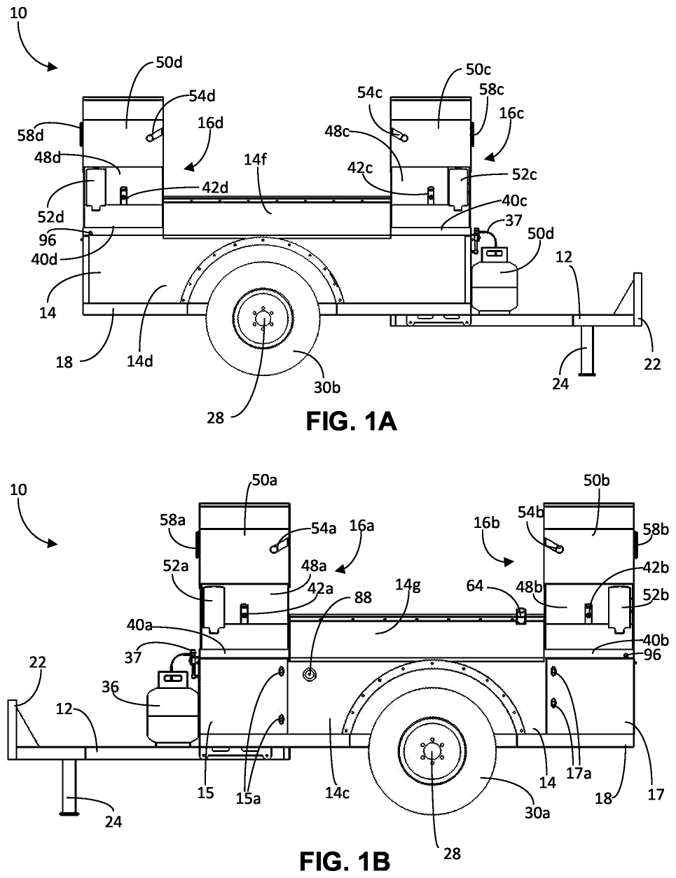

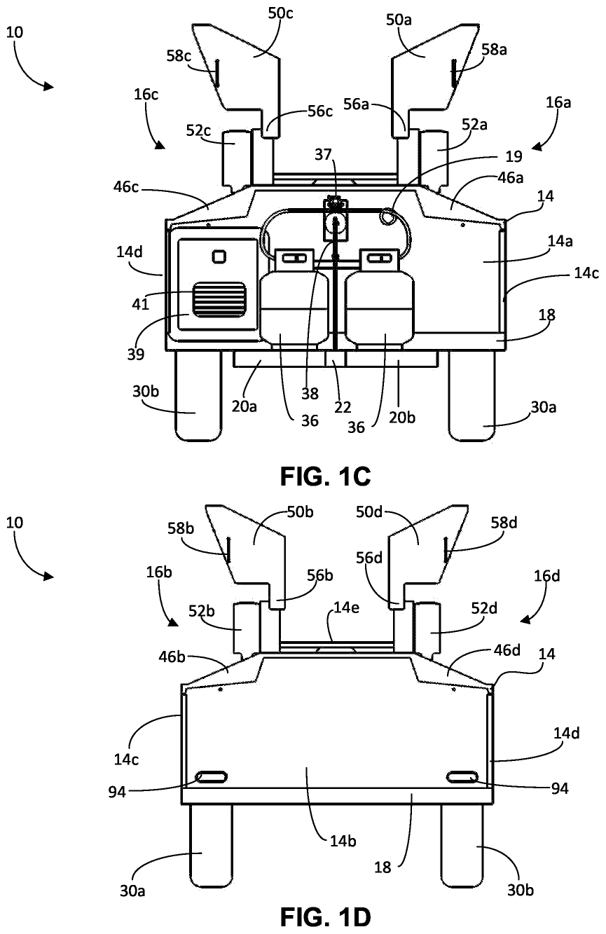

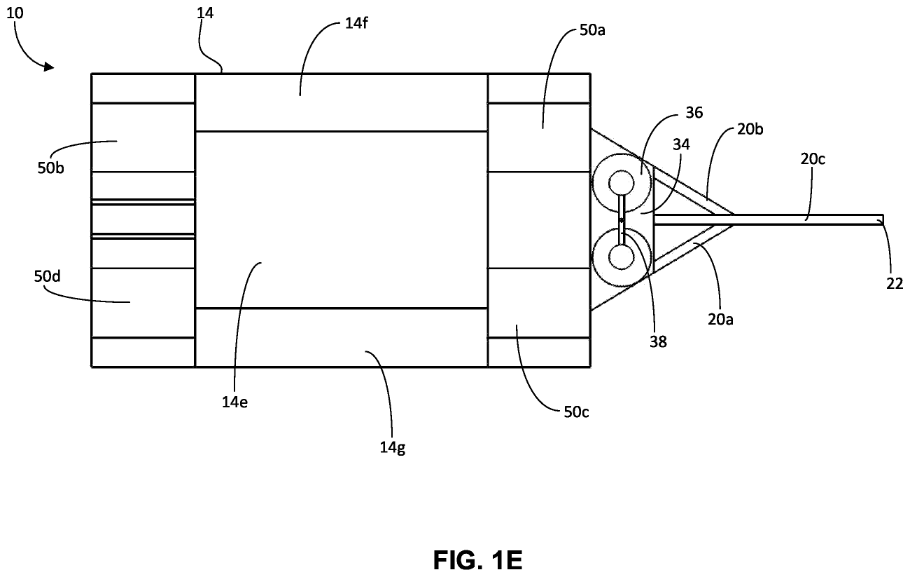

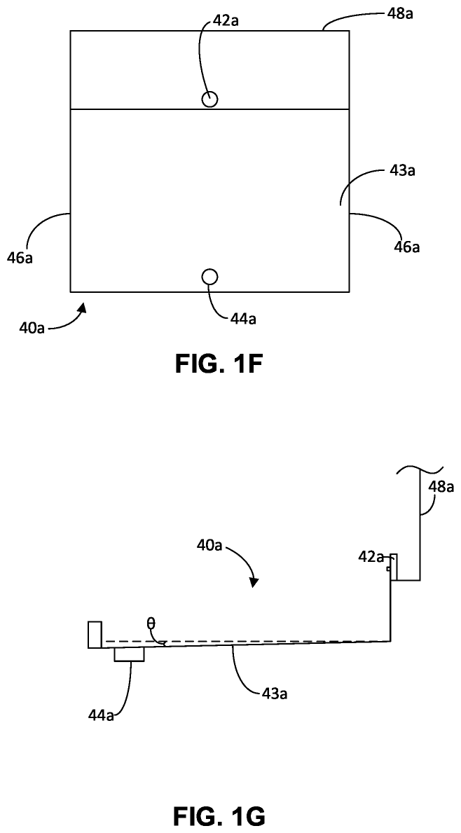

With reference now to FIGS. 1A-1E, 3 and 4, a hand washing unit according to a first embodiment of the present disclosure is shown generally as 10. Hand washing unit 10 may include a base unit 12, housing 14, four washing stations 16a, 16b, 16c and 16d, a fresh water tank 60, a water pump 66, a heating and mixing system 82 and a waste water tank 62.

In this embodiment, the base unit 12 supports the hand washing unit 10 and is a trailer base, which includes a generally rectangular frame 18, with three connecting members 20a, 20b, 20c extending from the front of frame 18 (FIG. 1E). Connecting members 20a, 20b may be arranged in a generally V-shape, with member 20c extending therethrough. Frame 18 and connecting members 20a, 20b, 20c may be manufactured from any suitable material such as tubular steel (for example 3 inches by 2 inches tubular steel) and may be fixedly connected by any method, such as by welding.

Located at the distal end of member 20c is a ball hitch 22 which is sized and configured to attach to the tow hitch of a vehicle (not shown). When the ball hitch 22 is unattached to the vehicle, the front end of hand washing unit 10 may be supported by jack 24 which may be adjusted to ensure unit 10 is substantially level.

The rear of trailer base 12 is supported by a single axle 28 attached to frame 18 and also includes rotatably mounted wheels 30a and 30b on the respective left and right sides of unit 10. Wheels 30a and 30b are sized to support the overall weight of the hand washing unit 10.

With reference to FIG. 1E, affixed to the top surfaces of members 20a, 20b, 20c at the distal end may be a mounting plate 34, affixed by a suitable method, such as welding. Mounting plate 34 functions to provide a surface for a pair of propane tanks 36 to be mounted and also provides additional strength and rigidity to frame 18. A securing device 38, such as a clamp or adjustable strap, operates to securely retain propane tanks 36 in the illustrated position.

Housing 14 may be a generally rectangular structure, comprising front panel 14a, rear panel 14b and respective left and right panels 14c and 14d, extending upwards from trailer base 12. The upper surface of housing 14 is defined by top panel 14e, flanked by respective left and right sloped panels 14f and 14g. Panels 14a-14g may be made from any suitably strong material, such as PVC coated aluminium, and may be affixed together by any suitable method, such as riveting.

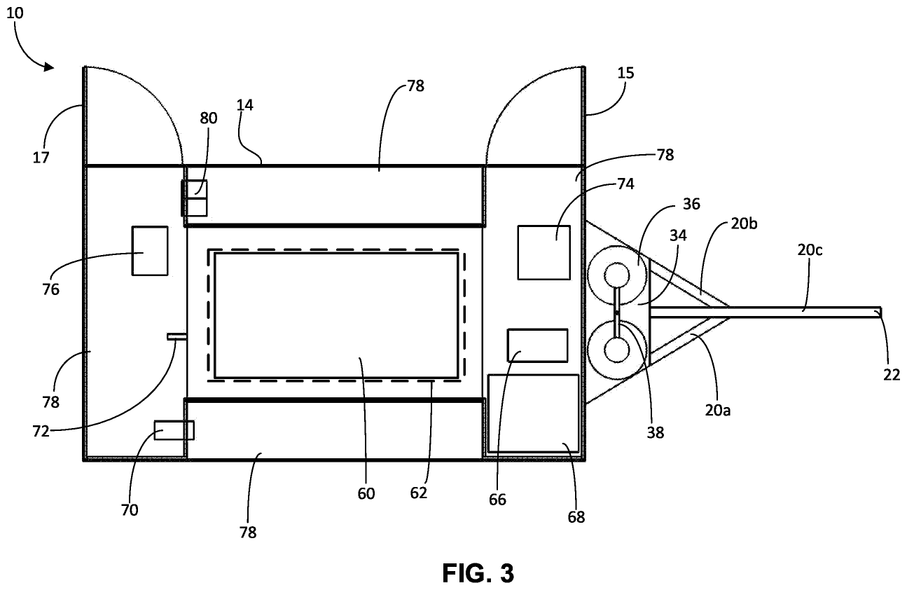

As depicted in FIG. 1B, panel 14c may include outwardly opening access doors 15 and 17. Doors 15 and 17 may be opened from the closed configuration shown in FIG. 1B to the open configuration depicted in FIG. 3 and allow access to the internal components of hand washing unit 10. When in the closed configuration, doors 15 and 17 are secured by locks 15a and 17a respectively.

Positioned at each upper corner of housing 14 are washing stations 16a-16d which may be constructed from similar materials in a similar manner and are operable to wash a user's hands or face or other object. Washing station 16a is shown in greater detail in FIGS. 1F and 1G and includes a sink 40a and a faucet 42a. Sink 40a may include a sink base 43a, which slopes outwardly from the centre of unit 10 in order to direct clean water dispensed from the faucet 42a towards a drain 44a. In an embodiment, sink base 43a inclines at an angle, θ, of about 3 degrees towards drain 44a (FIG. 1G). Two side walls 46a and backsplash 48a (FIG. 1C) project vertically upwards from sink base 43a and function to minimize splashing and assist in directing clean water towards the drain 44a. In a similar manner as described above, washing stations 16b-16d may include sinks 40b-40d, faucets 42b-42d, sink bases 43b-d, drains 44b-d, side walls 46b-46d and backsplashes 48b-48d. Faucets 42a-42b may be any suitable faucet, such as a ball faucet, disk faucet, cartridge faucet or compression faucet. In one embodiment, faucets 42a-d may be cartridge faucets, such as Moen M-Press metering faucets.

In an embodiment, sink bases 43a-d have a length of between about 10-20 inches or about 12-16 inches or about 14 inches and a width of between about 15-25 inches or about 19-21 inches or about 21 inches. Adjacent washing stations, such as washing stations 16a and 16d may be positioned between about 75-85 inches or about 78-82 inches or about 81 inches apart from each other, when measuring the distance between drains 44a and 44b.

Washing stations 16a-16d may also include hoods 50a-50d, soap dispensers 52a-52d and paper towel dispensers 54a-54d. Hoods 50a-50d may project vertically up from the inboard end of sinks 40a-40d. Soap dispensers 52a-52d are affixed to the outwards facing side of backsplashes 48a-48d and may be foaming hand soap dispensers, such as Gojo ADX-12 soap dispensers. Paper towel dispensers 54a-54d are positioned adjacent to the sinks 40a-40d and may include a retaining mechanism to hold a paper towel roll.

Sinks 40a-40d, backsplashes 48a-48d, hoods 50a-50d and paper towel dispensers 54a-54d may be manufactured from any suitable non-porous material, such as stainless steel, metal, composite or plastic.

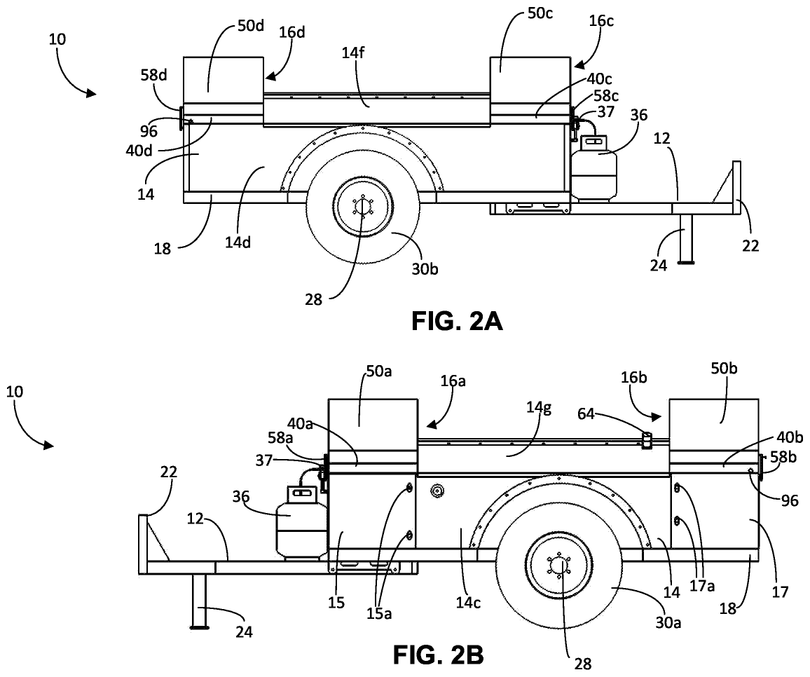

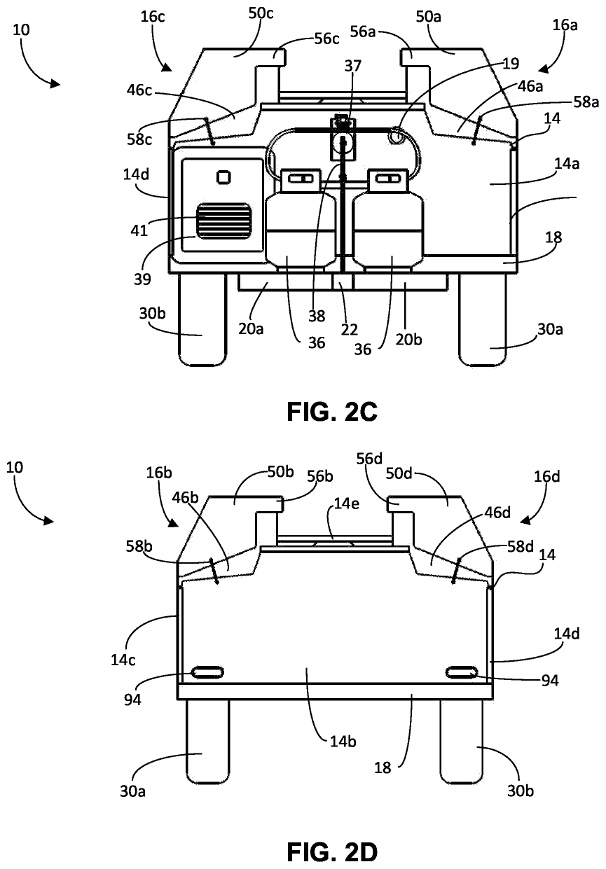

In one embodiment, hood 50a may be pivotably connected to backsplash 48a through pivotable mechanism 56a and is operable to pivot hood 50a through 90 degrees from a first position shown in FIGS. 1A-1D to a second position shown in FIGS. 2A-2D. Hood 50a may be locked in the second position by hold down latch 58a. Similarly, hoods 50b-50d may be movable through respective pivotable mechanism 56b-56d and secured in a second position with hold down latches 58b-58d.

The first position shown in FIGS. 1A-1D may be an operational configuration where hoods 50a-50d function to partially shelter a user from inclement weather, such as wind, snow and rain, and to allow access to paper towel dispensers 54a-54d, which are affixed to inner faces of hoods 50a-50d. The second position shown in FIGS. 2A-2D may be a transport or storage configuration, where hoods 50a-50d advantageously function to shield and protect washing stations 16a-16d from wind and rain or flying debris, for example.

Turning to FIG. 3, a partial cross-sectional top plan view of hand washing unit 10 is shown. Positioned approximately centrally within housing 14 and supported by frame 18 may be fresh water tank 60 and waste water tank 62. Fresh water tank 60 is operable to receive and store a supply of fresh (or clean) water through fill spout 64 (FIG. 1C) and is in fluid communication with each of the washing stations 16a-16d. Waste water tank 62 is also in fluid communication with each of the washing stations 16a-16d and is operable to receive and store waste water (i.e. run-off or dirty water) from the drains 44a-d of the sinks 40a-40d. In one embodiment, waste water tank 62 may be positioned directly below fresh water tank 60 such that the tanks 60, 62 may exchange heat with each other. This may aid in preventing water stored in tanks 60, 62 from freezing during cold weather conditions.

In an embodiment, fresh water and waste water tanks 60, 62 may both have a length of about 5 feet, a width of about 3 feet and a height of about 1 foot and may have a capacity of about 425 litres. Fresh water and waste water tanks 60, 62 may be manufactured form any suitable material, such as stainless steel and may include internal baffles (not shown) to minimize water movement when the unit is being transported to or from a location. In some embodiments, fresh water tank 60 may be secured to waste water tank 62 by any suitable method, such as welding or an adjustable strap.

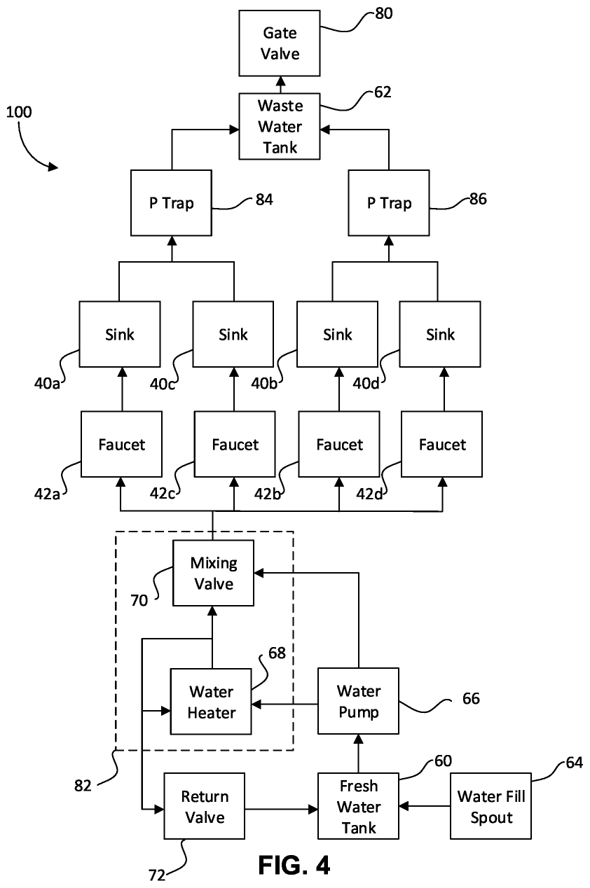

Fresh water tank 60 may be vented though a water fill spout 64, which exits through panel 14g in housing 14 (FIG. 1B). Extending through front panel 14a may be a AC inlet 19 (FIG. 1C), which may be a AC 120V, 15 amp plug, operable to receive AC power from an external source. Waste water tank 62 may be vented through a line (not shown) exiting housing 14 and may be drained through gate valve 80 (see FIG. 4), which may be accessed through access door 17. Gate valve 80 may also include a hose adaptor for connecting hosing to enable waste water to be drained from waste water tank 62, such as through connection to a tanker truck.

With reference to FIG. 3, located within housing 14 and supported by frame 18 is water pump 66, a heating and mixing system 82 (see FIG. 4) including a water heater 68 and a mixing device or mixing valve 70, a return valve 72, a battery 74 and an interior heater 76. In some embodiments, housing 14 may be lined with insulation 78 which functions to reduce sound generated from the components of unit 10 and to insulate components therein from external temperatures. The water pump 66 may be any water pump suitable to deliver clean water from fresh water tank 60 to the washing stations 16a-16d, such as a self-prime regenerative pump, for example a Shurflo 4048 fresh water pump, a centrifugal pump or pressure booster pump.

Water heater 68 may be any heater suitable for heating water, such as a storage tank water heater, a tankless (or on demand) water heater, for e.g. a Truma Aqua Go Comfort Plus water heater, a heat pump water heater or a solar powered water heater. In some embodiments, the water heater 68 may be an electric water heater which converts electricity into thermal heat to heat water. In other embodiments, the water heater 68 may be a propane water heater which uses gas and an internal flame to heat water. In the embodiment shown in the FIGS., the water heater 68 is a propane water heater that is in fluid communication with propane tanks 36 through regulator 37 (FIG. 1C). Water heater 68 may be accessed through water heater panel 39 in panel 14a of housing 14. Panel 39 includes a grill 41 to vent exhaust gases from water heater 68 to the atmosphere.

Interior heater 76 functions to heat the interior of housing 14 and may be activated during colder weather conditions to prevent water within hand wash unit 10 from freezing. An example of interior heater 76 is a Temro 900 W heater.

The battery 74 may be sized and operable to deliver sufficient power to operate the water pump 66, water heater 68 when an electric water heater, interior heater 76 and any other component within unit 10 that needs power. In one embodiment, the battery may be a 12V battery, such as an AGM 12V battery.

With reference now to FIG. 4, a block diagram showing a water system 100 for use in hand washing unit 10 of the present disclosure is shown. A volume of clean water may be loaded into and stored in fresh water tank 62 through water fill spout 64. The clean water loaded into fresh water tank 60 may be from any suitable source known to those skilled in the art, such as a tanker truck or mains supply. The term “fresh” (or “clean”) water as used herein refers to water suitably pure and free of contaminants so as can be used for hand washing. Clean water is dispersed from fresh water tank 60 by water pump 66. Thus, fresh water tank 60 is in fluid communication with water pump 66. In overview, water pump 66 is operable to disperse clean water from water tank 60 and supply clean water to washing stations 16a-16d and in particular, faucets 42a-42d. A heating and mixing system 82, comprising a water heater 68 and mixing device or mixing valve 70, is in fluid communication with the outlet of water pump 66. Thus, water pump 66 is operable to supply clean water from fresh water tank 30 directly to mixing device or valve 70 and to supply clean water from fresh water tank 60 to water heater 68, which is in turn in fluid communication with mixing valve 70. Water heater 68 is operable to raise the temperature of water passing therethrough yielding heated water with an elevated temperature relative to the temperature of the clean water supplied to water heater 68. Mixing device or mixing valve 70 is in fluid communication with faucets 42a-42d. In one embodiment, mixing valve 70 is a thermostatic mixing valve and is operable to blend the heated water from water heater 68 and clean water from fresh water tank 60 to produce a supply of clean water to faucets 42a-d at a pre-determined temperature. The mixing valve 70 may be adjusted accordingly in order to vary the pre-determined temperature of clean water supplied to faucets 42a-42d. In one embodiment, the pre-determined temperature may be a temperature within the range of about 35°−40° C. In another embodiment, mixing device 70 is an in-line static mixer and is operable to blend the heated water from water heater 68 and clean water from fresh water tank 60 to produce a supply of clean water to faucets 42a-42d at the pre-determined temperature above.

Water system 100 may also include a return valve 72 which is in fluid communication with the outlet of water heater 68 and fresh water tank 60. and when opened, controls a flow of heated water from water heater 68 to fresh water tank 60. This may be desirable in order to raise the temperature of the clean water in fresh water tank 60, for example, in order to prevent the clean water in fresh water tank 60 from freezing. As described above, fresh water tank 60 may be positioned directly above waste water tank 62 such that heat from tank 60 may radiate towards waste water tank 62 to assist in preventing the waste water in waste water tank 62 from freezing. Thus, water system 100 is capable of operating at temperatures at or below as −15° C. and is therefore suitable for multi-season use in North America and other parts of the world.

Clean water is dispensed though faucets 42a-42d, and after washing, is collected in respective sinks 40a-d as waste water. Waste water may contain contaminates such as dirt, grease, oil, soap or food. In overview, waste water is collected in sinks 40a-40d and passed through drains 44a-d which are in fluid communication with waste water tank 62. Waste water tank 62 is operable to receive and store waste water from sinks 40a-40d prior to appropriate water treatment or disposal through gate valve 80 (FIG. 3).

In the embodiment shown in FIG. 4, waste water from sinks 40a and 40c, located at the front of hand washing unit 10, is collected and supplied to waste water tank 62 via a P-Trap 84. In a similar manner, waste water from sinks 40b and 40d, located at the rear of hand washing unit 10, is collected and supplied to waste water tank 62 via a P-Trap 86.

During use, a user may activate any one of faucets 42a-42d which causes clean water at the pre-determined temperature to be dispensed through the activated faucet for a pre-determined time. Waste water, after washing, is collected in sinks 40a-40d and flows into waste water tank 62 where the waste water may be stored. Using a faucet operable to deliver clean water for a pre-selected cycle time may ensure sufficient time for a user to maintain good hand washing practices, without the use of excess clean water.

As one skilled in the art will appreciate, the water system 100 can adopt any other suitable configuration in order to supply water from a fresh water tank to any number of separated washing stations, and collect and combine the waste water in a waste water tank.

Any of the fluid connections described above may be achieved through any conventional tubing or piping known to those skilled in the art. For example, such connections may be achieved through polyvinyl chloride (PVC), chlorinated polyvinyl chloride (CPVC), copper, galvanised steel piping, stainless steel, cross-linked polyethylene (PEX) pipes, polypropylene or other similar plumbing fixtures. In a preferred embodiment hand washing unit 10 uses PEX piping.

In other embodiments, water system 100 may be configured to supply separate streams of heated and unheated clean water from fresh water tank 102 to separate hot and cold water faucets of a washing station. For example, water pump 66 may pump clean water from fresh water tank 60 directly to cold water faucets through a cold water outlet. Thus, the cold water outlet of water pump 66 is in fluid communication with the cold water faucets of each washing station. For heated water, water pump 66 may pump clean water to water heater 68 through a hot water outlet. Thus, the hot water outlet of water pump 66 is in fluid communication with the water heater 68. Upon receiving clean water, water heater applies heat to the clean water to raise the temperature of clean water to produce warm or hot water which can then be supplied to hot water faucets of the washing stations. Thus, the water heater 68 is in fluid communication with the hot water faucets.

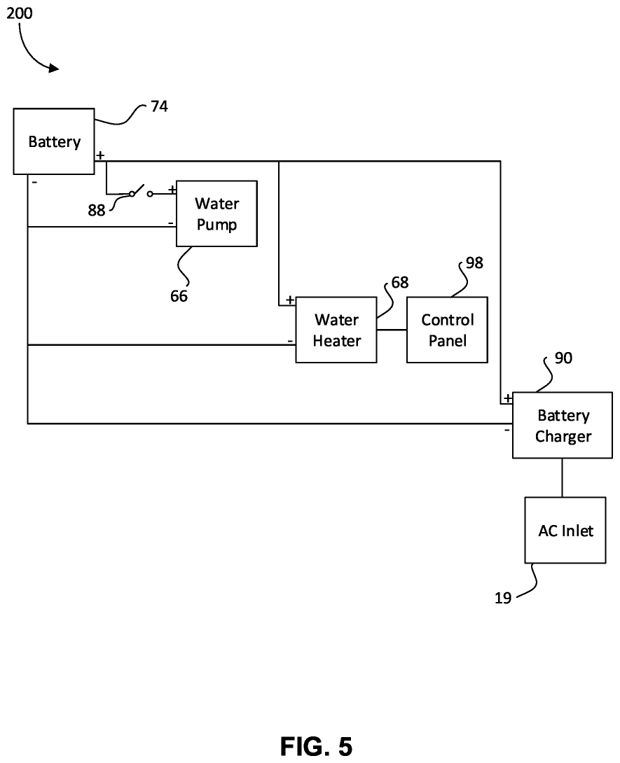

Referring now to FIG. 5, battery 74, which may be an AGM DC 12V battery, powers water pump 66 and water heater 68 when water heater 68 is an electric water heater, and interior heater 76 (not shown). When hand washing unit 10 is in use, water pump 66 may be activated by switch 88, which is positioned on the outer surface of panel 14c of housing 14 (FIG. 1B). Water heater 68 may be in communication with a control panel 98, which may be located behind access door 15, adjacent to battery 74. Battery 74 may also be in electrical communication with a battery charger 90 which is operable to maintain the charge of battery 74 when connected to an AC power supply though AC inlet 19.

Where hand washing unit 10 includes a trailer base 12, the unit may further include tail lights 94 (FIG. 1C) affixed to panel 14b and clearance lights 96 (FIGS. 1A and 1B), affixed to panels 14c and 14d.

In another embodiment, the base unit of hand washing unit 10 is a skid base which may be moved by any suitable vehicle such as a forklift truck. For transporting over longer distances, the hand wash unit 10 may be loaded onto a truck and transported to the desired location. In this configuration, larger fresh and waste-water tanks may be advantageously accommodated as the hand washing unit may be transported on a vehicle with larger weight capacity, such as a semi-trailer. This will enable a greater number of hand washes between servicing of the unit.

In other embodiments, the hand washing unit 10 may be configured to receive an external supply of clean water and may be connected to an external drain or waste water tank, enabling continuous use without the requirement to refill or empty the fresh and waste water tanks. When the unit is also connected to an AC power source, uninterrupted use of the hand washing unit may be achieved which may be advantageous when the hand washing unit is required for use for a prolonged period of time, or by a high volume of users.

Clean water may be supplied to each of the washing stations at any suitable temperature through adjustment of the thermostatic mixing valve. In a specific embodiment water is supplied to the faucets of the washing station at about 35° C.-40° C., such as about 38° C. The faucets may be configured to supply water for a fixed period of time in order to encourage compliance of the user to best hand washing practices without wasting water. In a specific embodiment the faucet may supply water a constant flow rate for a time period of about 20-25 seconds, such as about 22 seconds. This will also prevent the faucet from unintentionally being left running.

In another embodiment, the hand washing unit 10 may include an electric hand drier which may be connected to the onboard DC power supply or connected to an external power supply, if available.

In another embodiment as noted above, water heater 68 may be an electric water heater, such as an electric immersion heater powered solely by battery 74 or through an electrical outlet.

In a further embodiment, a hand washing unit of the present disclosure may be in fluid communication with at least one external slave washing station which may be configured in a similar manner to the washing stations described above, but operating as a separate, stand-alone unit. When connected to an external slave washing station, the hand washing unit functions to supply fresh water to and remove grey water from the slave washing station. This may allow more users to be accommodated or to increase the spacing between users.

In an embodiment, at least one of the hand washing stations or slave washing stations may be ADA (American Disabilities Act) compliant.

While the foregoing is directed to various embodiments of the present disclosure, other and further embodiments of the disclosure may be devised without departing from the basic scope thereof, and the scope thereof is determined by the claims that follow.

1. A portable hand washing unit, comprising:
(a) a base unit;
(b) a fresh water tank operable to receive and store a volume of clean water,
(c) a waste water tank operable to receive and store a volume of waste water,
(d) a plurality of washing stations, each washing station in fluid communication with the fresh water tank and the waste water tank,
(e) a water pump in fluid communication with the fresh water tank and the plurality of washing stations;
(f) a heating and mixing system in fluid communication with the water pump; and
(g) a power source in electrical communication with the water pump and heating and mixing system;
wherein:
the water pump is operable to disperse clean water from the fresh water tank to the plurality of washing stations; and
the heating and mixing system is operable to control the temperature of the clean water dispersed by the water pump to the plurality of the washing stations.

2. The portable hand washing unit of claim 1, wherein the heating and mixing system comprises a water heater and a mixing valve.

3. The portable hand washing unit of claim 2, wherein the mixing valve is a thermostatic mixing valve.

4. The portable hand washing unit of claim 2, wherein the water heater is a propane water heater.

5. The portable hand washing unit of claim 2, wherein the water heater is an electric immersion heater.

6. The portable hand washing unit of claim 1, wherein the base unit is a trailer.

7. The portable hand washing unit of claim 1, wherein the base unit is a skid.

8. The portable hand washing unit of claim 1, wherein the power source is a rechargeable battery.

9. The portable hand washing unit of claim 1, wherein the power source is an external power source.

10. The portable hand washing unit of claim 1, wherein the plurality of washing stations each comprise a sink and a faucet.

11. The portable hand washing unit of claim 10, wherein the water is dispersed to each faucet at a temperature of about 38° C.

12. The portable hand washing unit of claim 10, wherein the water is dispersed to each faucet for a fixed period of time.

13. The portable hand washing unit of claim 10, wherein the plurality of washing stations each further comprise a soap dispenser and a paper towel dispenser.

14. The portable hand washing unit of claim 1, wherein the number of washing stations is four.

15. A portable hand washing unit of claim 1 further comprising a housing with a plurality of hoods for each washing station, the hoods operable to move between an open position and a closed position, wherein in the open position a user can access the washing station and in the closed position the hood encloses the washing station.
